(19) United States
(12) Patent Application Publication
(10) Pub. No.: US 2010/0274574 A1
(43) Pub. Date: Oct. 28, 2010

(54) Computerised healthcare management method

(76) Inventors: Tobias Andersson, Copenhagen (DK); Lasse Strand Holm, Malmo (SE); Annette Andersson, Copenhagen (DK); Christa Lykke, Copenhagen (DK)

Correspondence Address: COOPER & DUNHAM, LLP, 30 Rockefeller Plaza, 20th Floor, NEW YORK, NY, 10112, US

(21) Appl. No.: 12/386,818

(22) Filed: Apr. 23, 2009

(51) Int. Cl. G06Q 50/00

(52) U.S. Cl. 705/2

(57) ABSTRACT

The present invention relates to a computerized healthcare management method for a patient. The method uses an interactive conversation tool which strengthens and structures prevention consultations regarding lifestyle changes. The patient is involved actively in the conversations and an overview of the measures/actions to be taken is established. According to the invention, a special navigation compass is provided with a view to creating the best possible overview, said navigation compass dividing and structuring the action plan, while at the same time compass changes in the form of resources and gains can be monitored and followed by the patient. By this, a method is achieved, which discloses the results to the patient to a higher extent than previously and thus creates a better structure and overview than before by means of simple data structures and simple data processing.

The present invention relates to a computerized healthcare management method for a patient.

WO 98/40835 discloses a disease management system. This system is related to a continuing medical care of a patient who has been diagnosed with a specified health problem. The system works via the internet in connection with a knowledge database. This system is, however, not particularly easy to grasp for the patient and is therefore not sufficiently encouraging.

The method according to the invention uses an interactive conversation tool which strengthens and structures prevention consultations regarding lifestyle changes. The patient is involved actively in the conversations and an overview of the measures/actions to be taken is established. According to the invention, a special navigation compass is provided with a view to creating the best possible overview, said navigation compass dividing and structuring the action plan, while at the same time compass changes in the form of resources and gains can be monitored and followed by the patient. By this, a method is achieved, which discloses the results to the patient to a higher extent than previously and thus creates a better structure and overview than before.

The invention is explained in detail below with reference to the drawings, in which

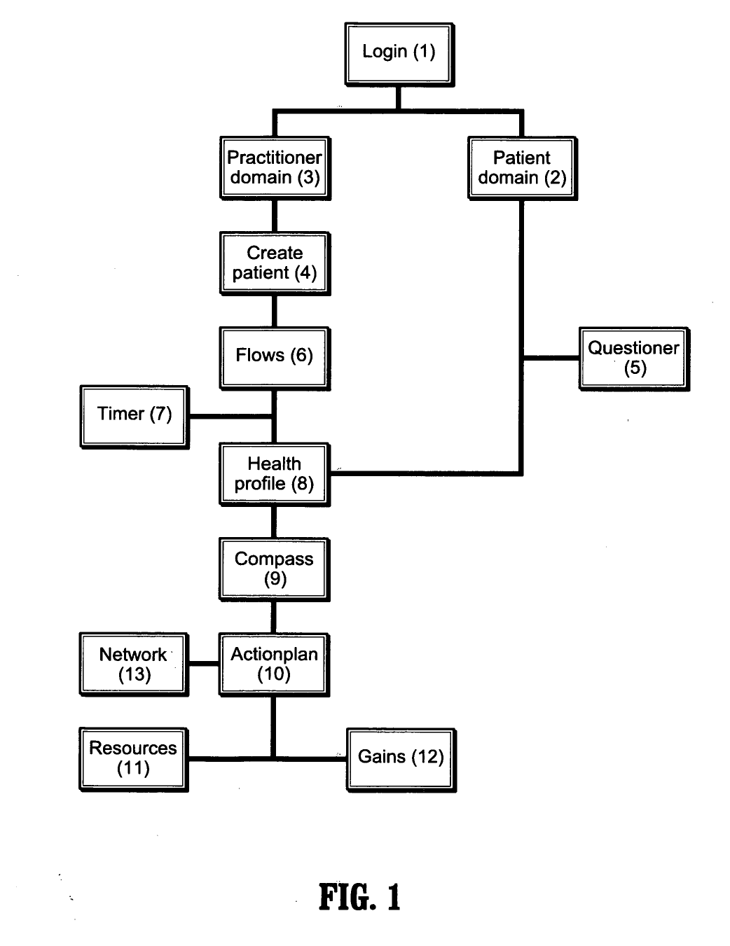

FIG. 1 shows a flow diagram of the method according to the invention for health care management,

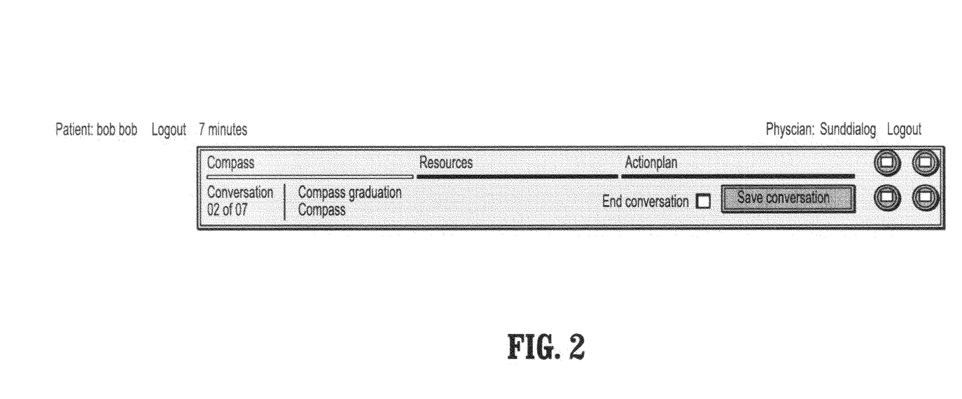

FIG. 2 an illustration of flow control and time registration,

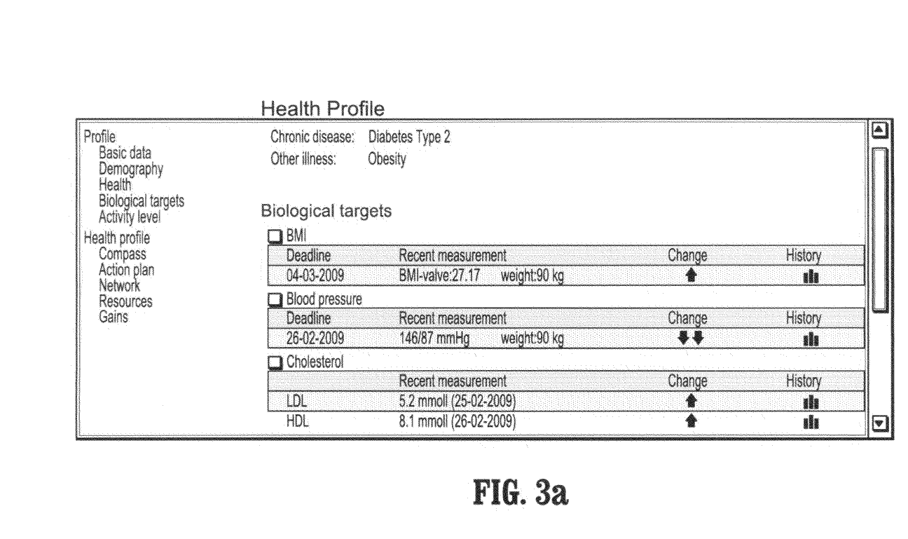

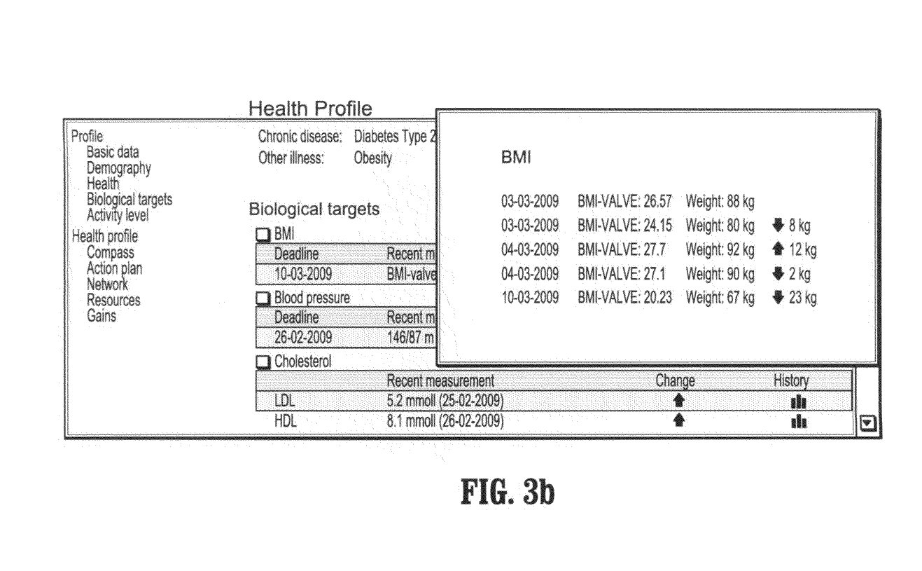

FIG. 3 a health profile,

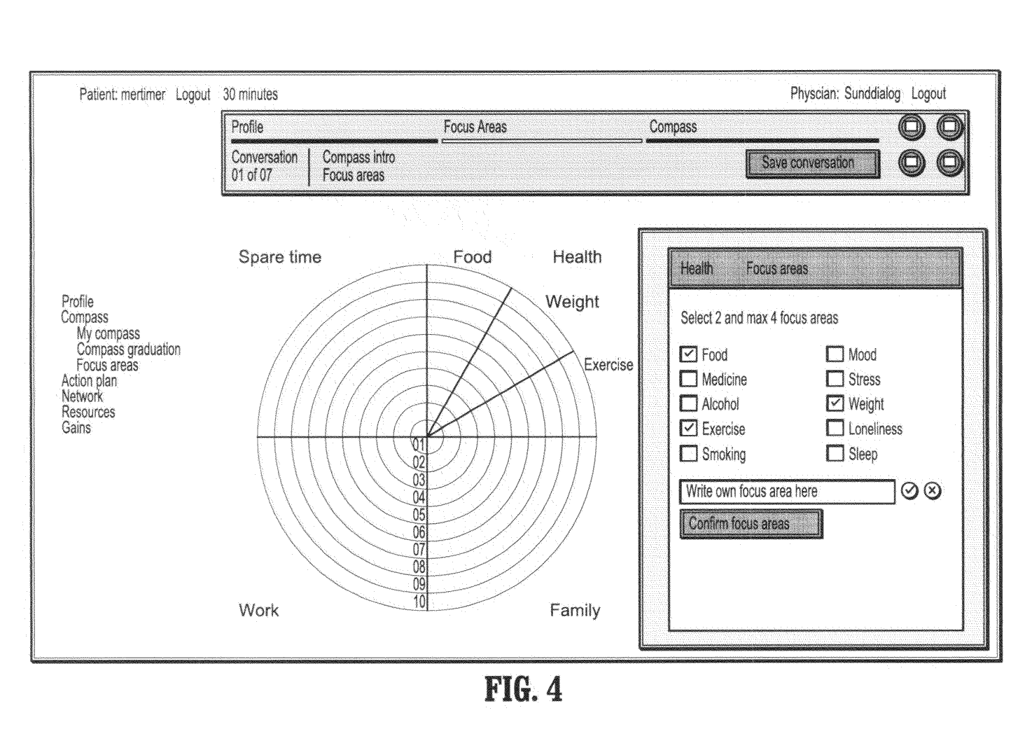

FIG. 4 focus areas,

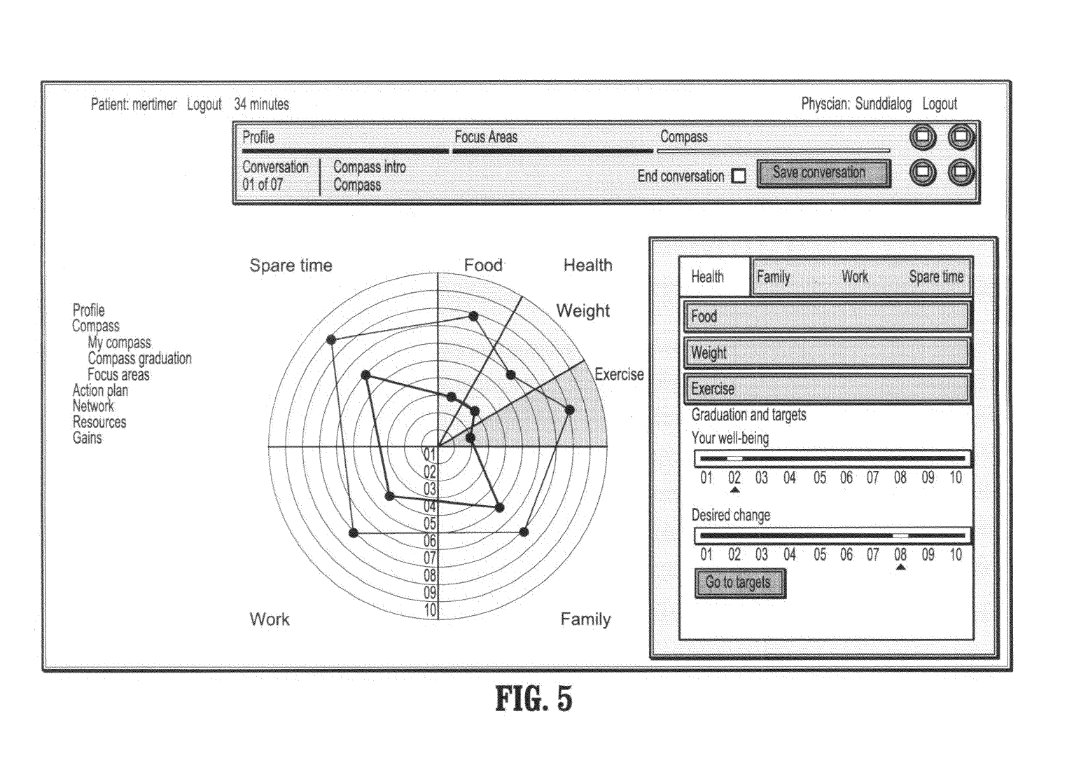

FIG. 5 compass graduation,

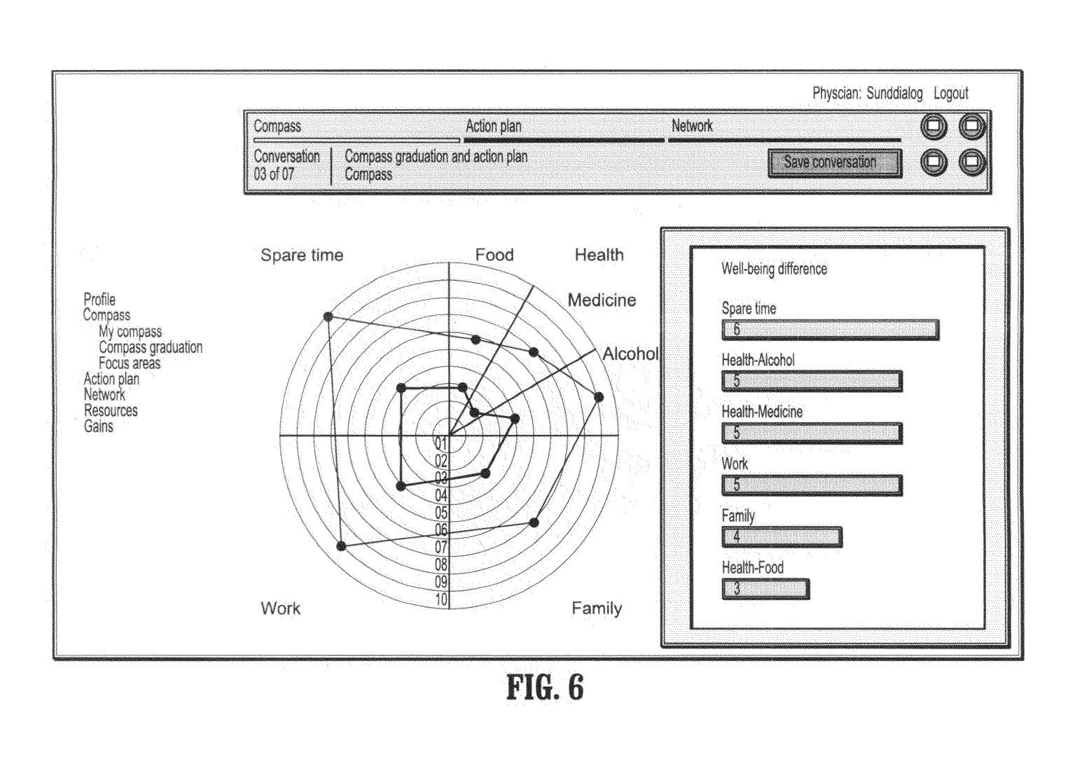

FIG. 6 compass with well-being difference in a hierarchic overview,

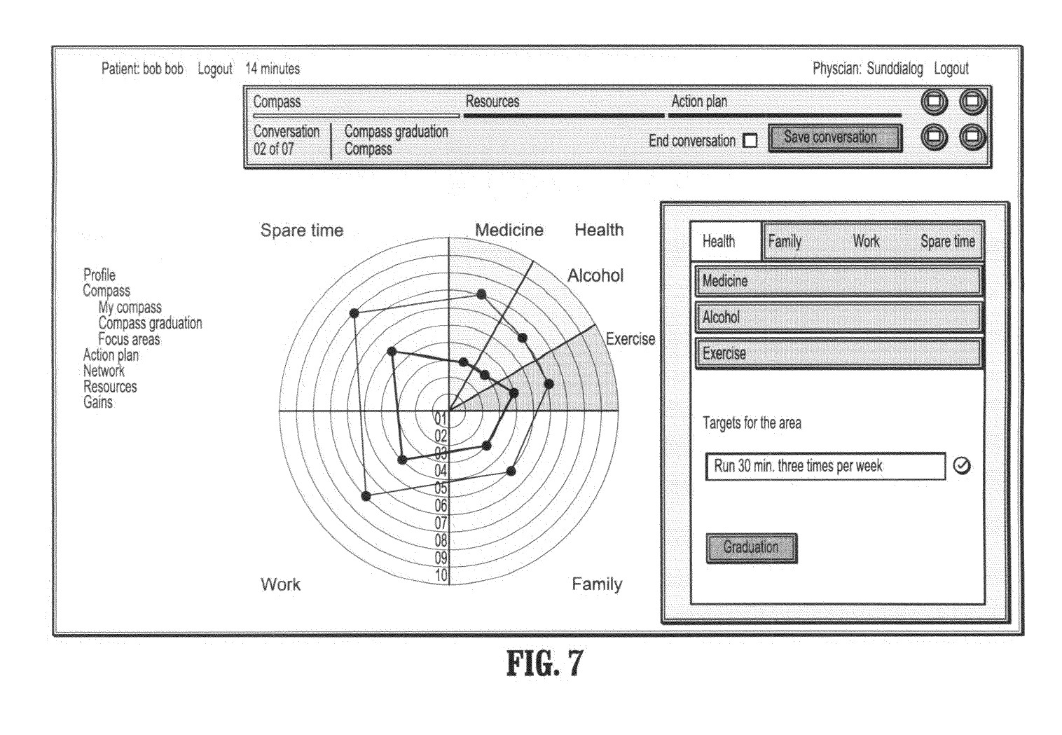

FIG. 7 compass with targets,

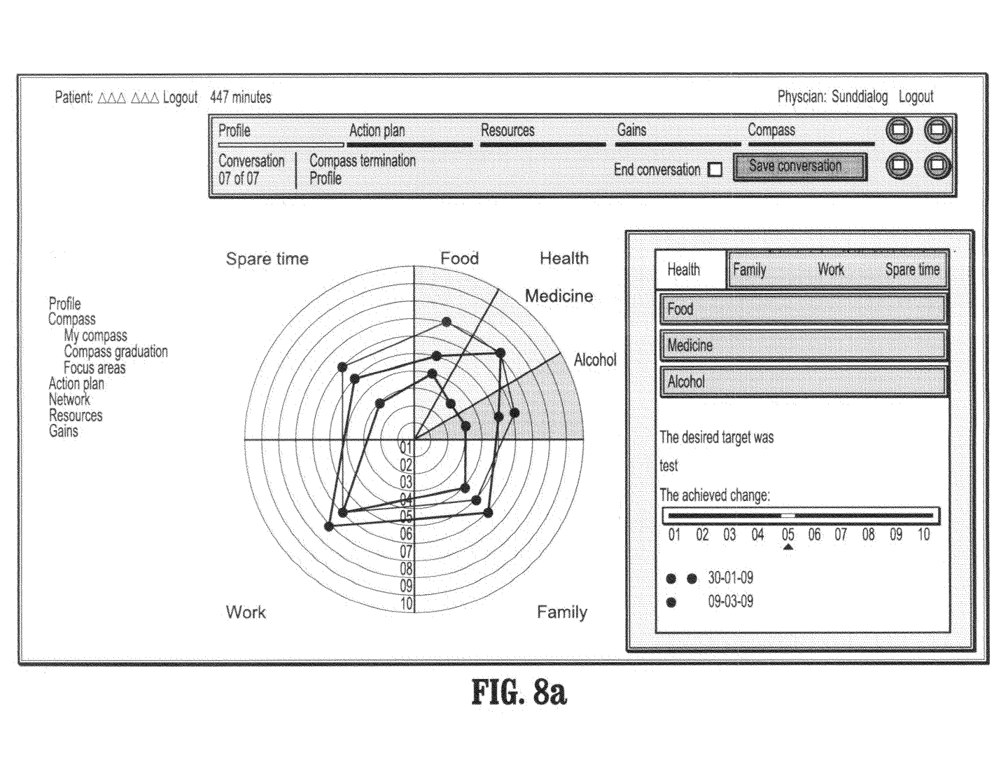

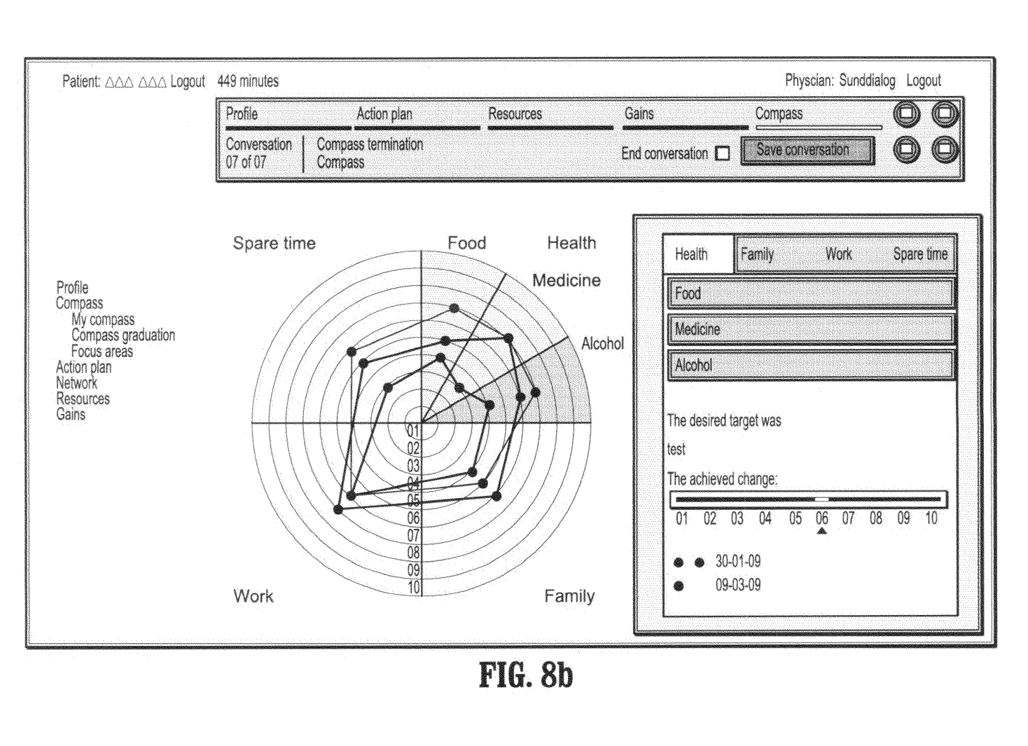

FIG. 8 compass with final graduation,

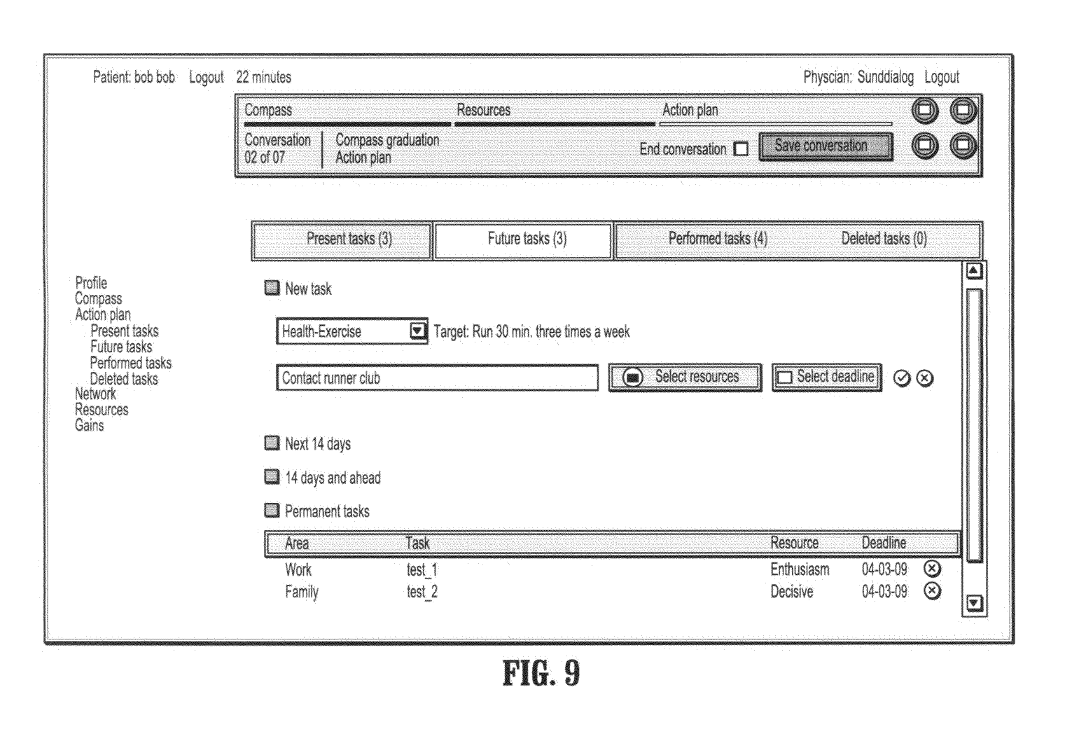

FIG. 9 action plan in connection with a new task,

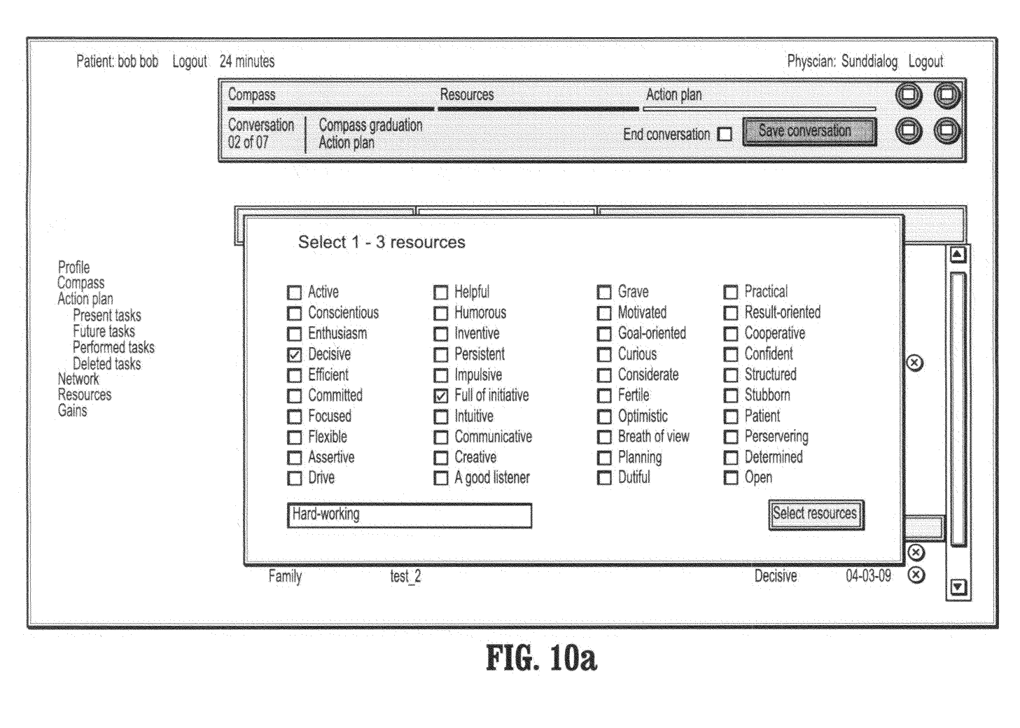

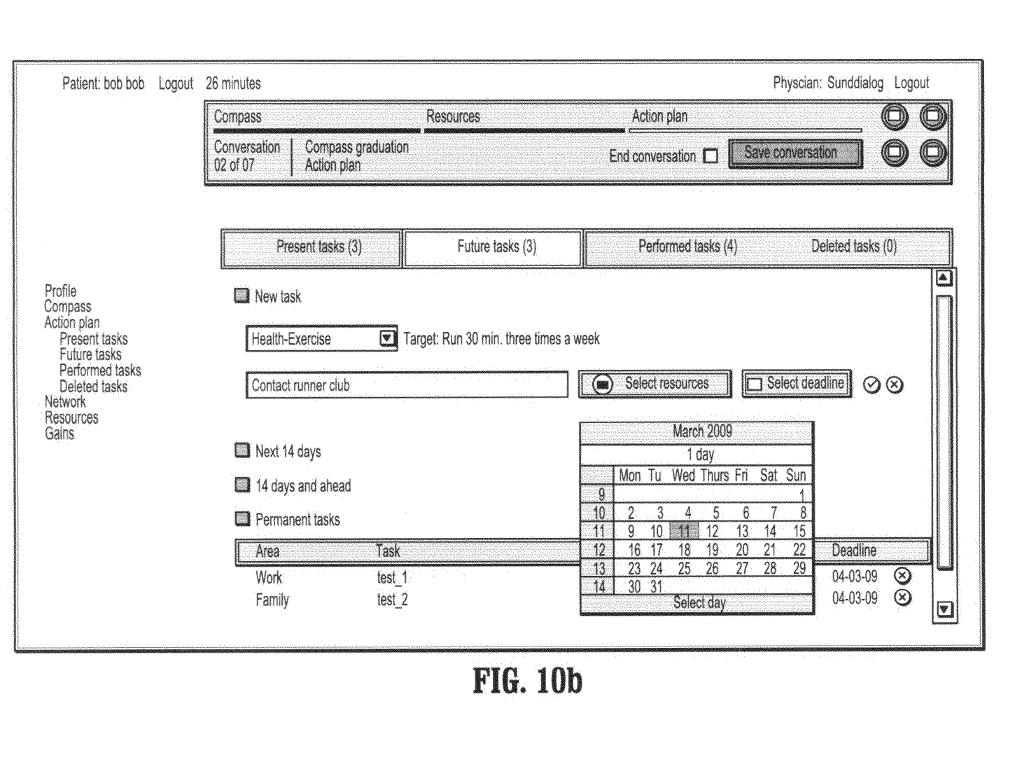

FIG. 10 resource selection in connection with the action plan,

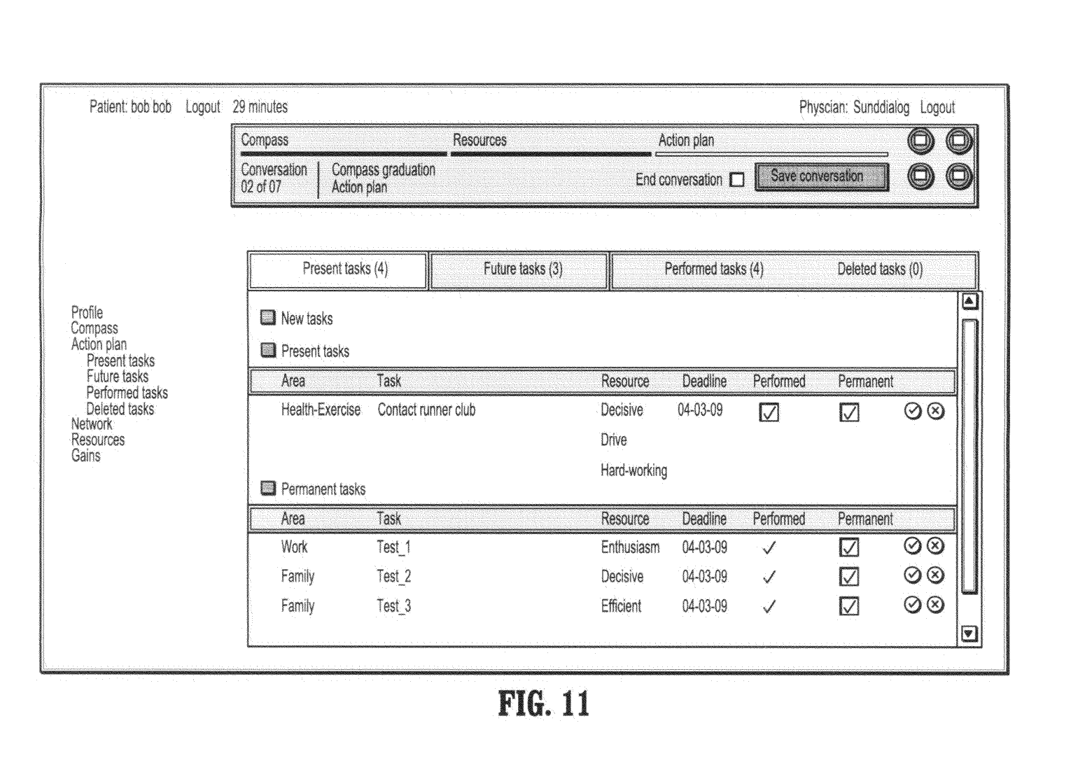

FIG. 11 division of the action plan,

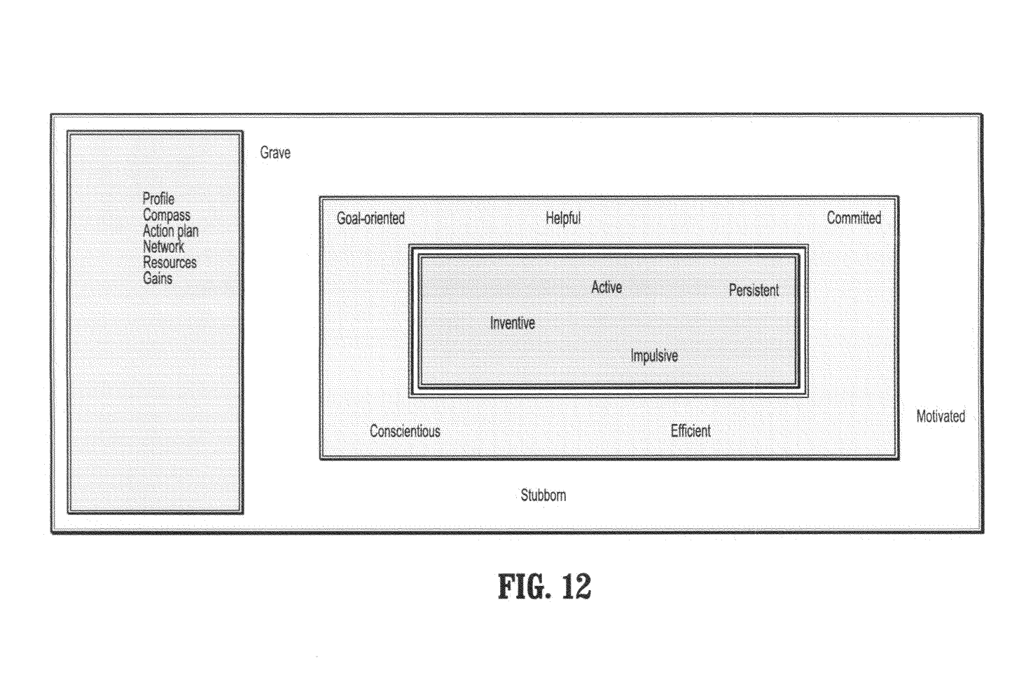

FIG. 12 resource chart,

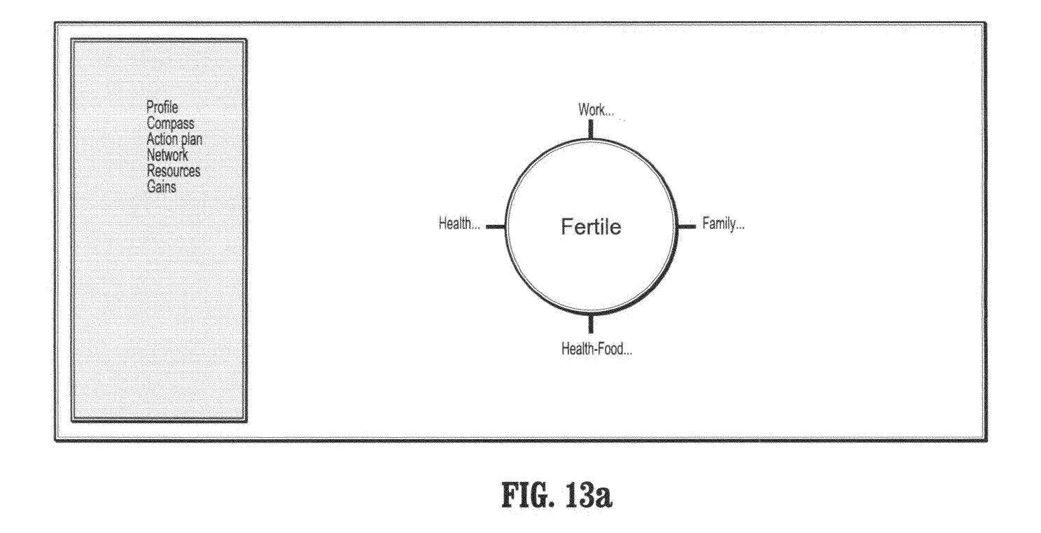

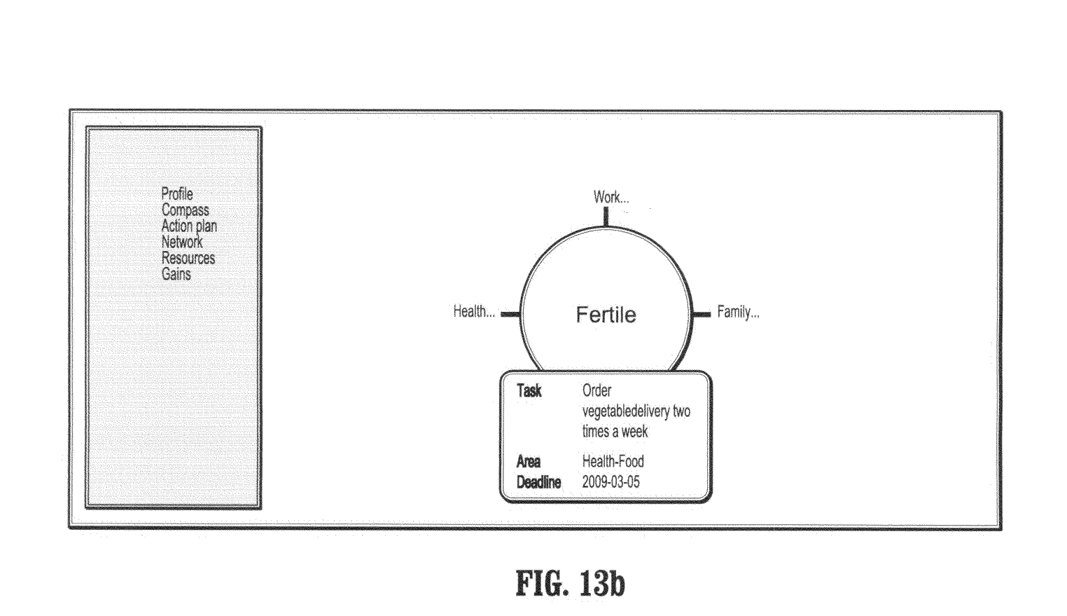

FIG. 13 resource chart with database retrieval,

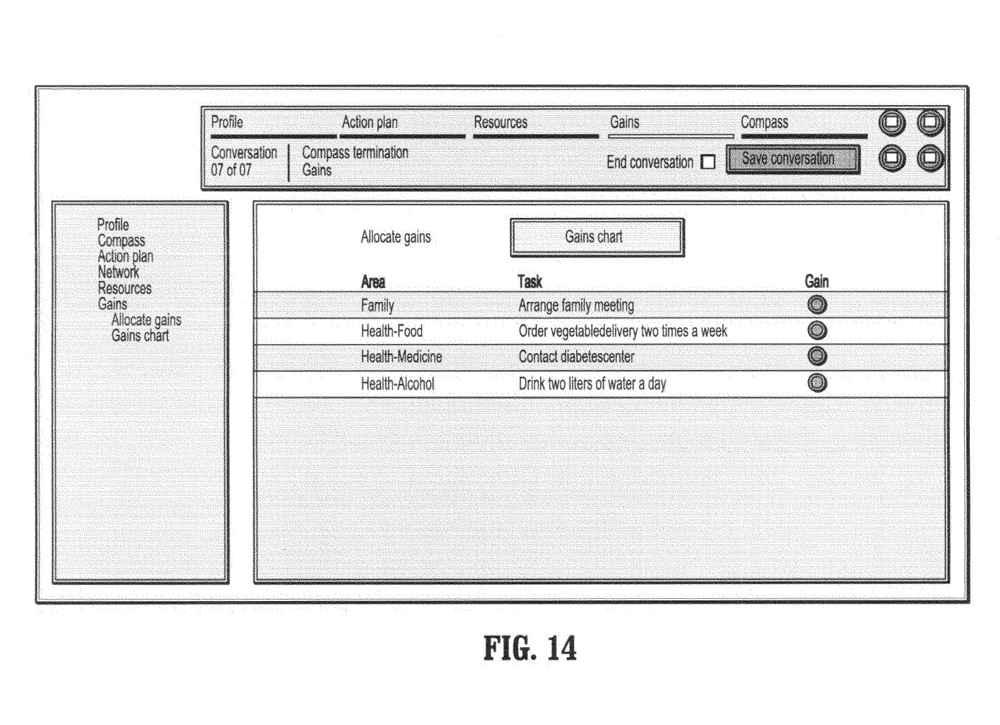

FIG. 14 allocation of gains,

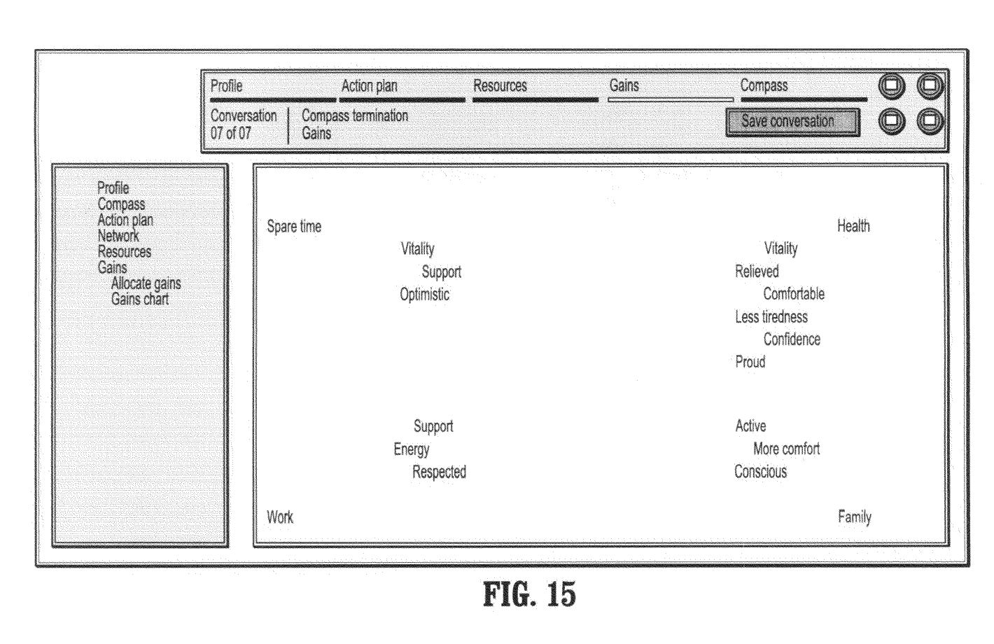

FIG. 15 gain chart,

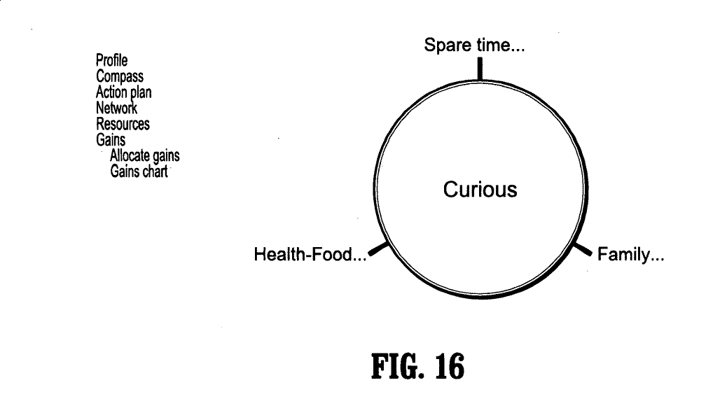

FIG. 16 gain chart,

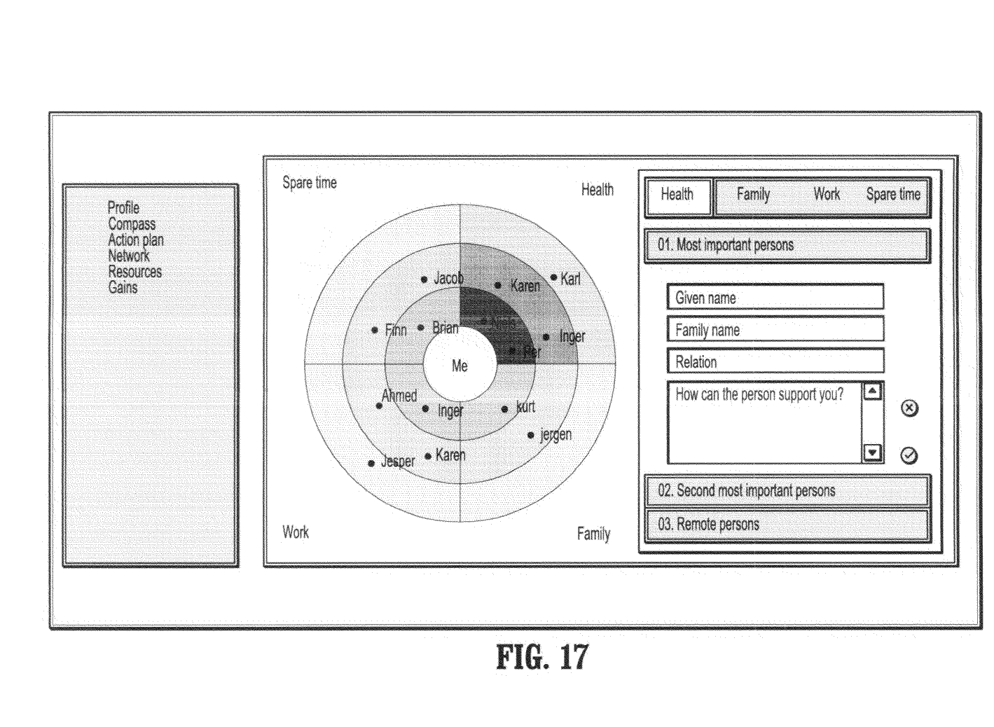

FIG. 17 network chart,

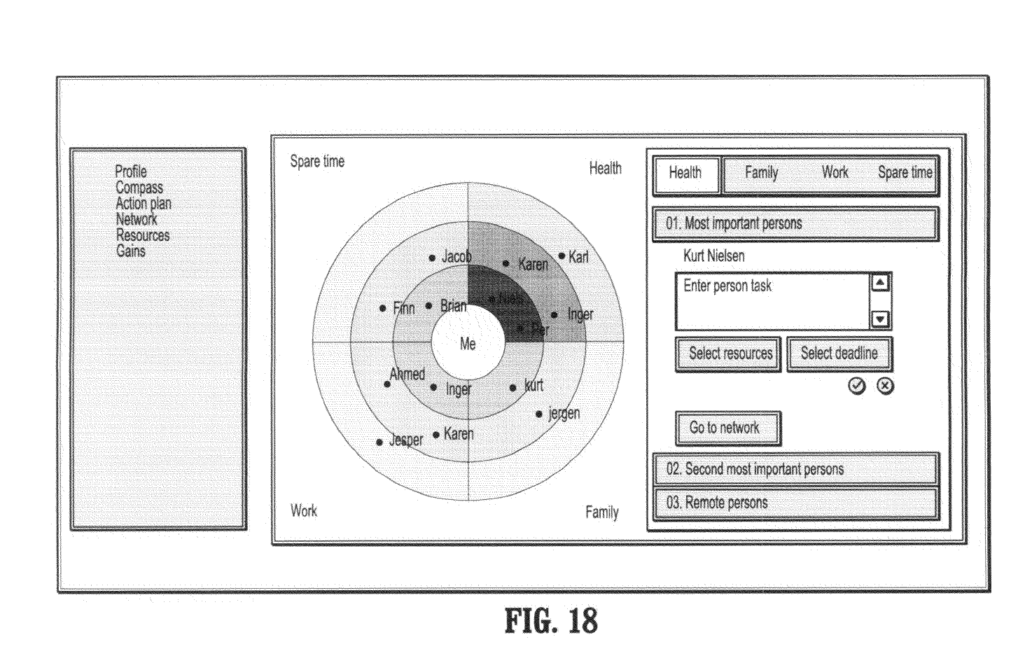

FIG. 18 tasks for the action plan and

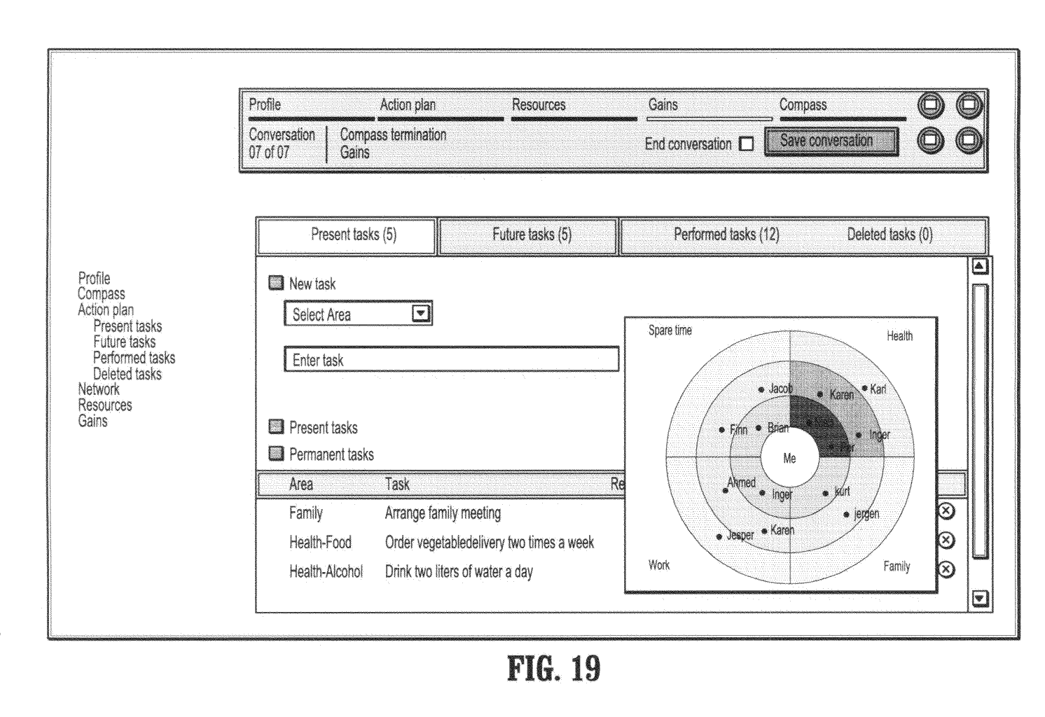

FIG. 19 action plan with network chart.

The well-being compass is the core of the conversation tool with the patient. The patient selects the focus areas himself. It may be food, exercise, medicine and smoking. Thus, the patient creates together with the physician a visualization of his life, and subsequently it is described in general how the patient can draw up main targets in consultation with the physician. For the achievement of these targets, the use and the consciousness of own resources are in focus.

The well-being compass is the core of the conversation tool with the patient and comprises a number of life areas, such as family (primary relations), work, spare time and health. In addition, the patient selects the focus areas to focus on during the conversations. These may be food, exercise, medicine and smoking. The target of all the areas is to work on increased well-being by creating and maintaining a healthy lifestyle and more healthy habits than before. The purpose of the well-being compass is that together with the physician the patient creates a visualization of his life and expresses the main targets to achieve. For the achievement of these targets, it is focused on making a realistic action plan. Further, the patient is made conscious of his potential unconscious resources, which may be used for improving his situation. Further, the compass serves to make the patient conscious of improvements and gains due to the behavioural change, so that the patient can see the advantage. The latter serves as motivation to continue.

The knowledge of one's resources may be increased by examining the resources used every day in various connections, in the family, at work and in the spare time. All people have resources. However, most people are unaware of their resources and of the importance of using these resources for gaining what they want, when for instance they want to change their lifestyle.

The well-being compass is divided into four main areas: family, work, spare time and health, which—by way of various indications—create a general picture of the life of the patient. This is achieved by identifying what has the most focus in the consciousness of the patient or what takes energy from the patient in the individual areas, in order to work on turning the negative thoughts and behaviour patterns to a positive behaviour.

Family Area

To thrive in the family is a basic need for most people if they are to have enough energy to change their habits and lifestyle. Thus, events in the family such as divorce, moving house, relationship problems, conflicts or the like have great effect on both the health and the work areas.

Within the family, patterns and habits are also created, which the patient often brings into the adult life.

Eating Habits

Most eating habits arise in the family and some may be traced back to the childhood, for instance the way in which food is prepared, the composition of the food and what is consumed in connection with enjoying oneself. It can be difficult to break old habits, because one has often been taught to eat in a certain way, and there may be pressure from the rest of the family “to act/eat as usual”. Support from children, spouse and other family members may thus be crucial for a success with new healthy habits.

Exercise Habits

Exercise habits may also be influenced by the family's relation to exercise, both in childhood and in adult life. As a child one has seen how the family handled exercise and has gained experience on one's own. It may therefore be relevant to examine whether the activities were a good or bad experience. If one is to succeed in implementing regular exercise habits, the present family's understanding, participation and support may have influence on one's success. Exercise is time consuming and the family may have to participate in the decision on how this may be done and for instance accept to take over practical chores etc.

Work Area

Work is another crucial factor in most people's life as work forms a great part of one's identity. In work places it is essential to think about the culture created in relation to for instance food, smoking and alcohol habits, which are rituals in connection with one's social relations.

In order to thrive in one's work place it is necessary that the competences correspond to the tasks and that one has the experience of using oneself correctly. The entire work environment affects one's well-being and perception of energy, and for instance bad management, conflicts or problems in terms of co-operation may result in stress and dissatisfaction.

Spare Time Areas

To find a balance between work, family and spare time activities also have effect on one's well-being. In the spare time area, one needs to spend time forming healthy and regular exercise habits. Often, the time needs to be taken from the family and work areas, which may be loaded with tasks, excuses, evasions and busyness. The healthy habits, which one tries to establish, must be integrated in the spare time area and replace old patterns, lack of time and unhealthy habits. The challenge is to create time to oneself and to prioritize one's targets without interruptions. Most people experience being met with many demands from the other areas so that the space for the spare time activities is limited, and as a consequence the exercise may be neglected.

Health Area

Most people are used to focussing on the health area, when they are in contact with their medical practitioner. The health occupies the entire consciousness of the patient and all symptoms and problems may be connected to this. However, many symptoms may be related to other life aspects.

In addition, lack of efforts in the health area often reflects corresponding lack of efforts in other life areas. If family or work problems occupy the mental energy of the patient, this prevents the patient from having energy to undertake the necessary actions in relation to behavioural changes in the health area.

During the first conversation with the patient, the relevant focus areas are laid down, such as food, smoking, medicine, exercise, alcohol, weight, stress, mood, insomnia and feeling of loneliness. These are marked on the compass on a scale from 1 to 10.

Based on these markings, the desire to change is established, which then results in a target statement within each of the focus areas. Said target statement may then be divided into work area targets, family area targets, spare time area targets and health area targets.

When the desired targets have been established, the tasks, which may help the patient reach his target, are decided upon and it is decided what resources should be activated in connection with the task. When the required resources have been determined, a deadline is fixed for the completion of the specific tasks.

Subsequently, it is determined whether these targets have in fact been achieved and the compass is adjusted correspondingly.

Now, the patient gains a clear picture of his progress and he will be more able to assess whether it has been worth the efforts. If this is the case, he will be motivated to continue and to maintain a healthier lifestyle than before.

The Process is Initiated in the Following Way:

The user can log in either as physician or as patient (at 1, see FIG. 1). The patient can only log in after having been given access by the physician (at 2). The physician has access to the patient overview via his domain, (at 3), including method description, user manual, various legal documents, patient questionnaire, a supervision forum for physicians, and clinic limited patient information and notes etc., as well as the opportunity to enter a new patient into the database via “create patient” (at 4).

In connection with the progress of the patient conversations and the relevant tools used in the clinic, the program automatically allows the patient the access to see his tool specific results via his personal online access (user ID). By start and termination of the process, the patient will, when logging in, automatically be asked to fill in an online questionnaire, which must be filled in before he can gain access to his personal data in the program (at 5). This implies an automatic quantitative data processing, which measures the difference for stating the patient's development. On this basis it is also possible on a continuous basis to assess any side-effects.

After a patient has been entered into the system database, a flow control 6 at the top of the flow diagram is activated at the same time, from where the specific conversations can be initiated and controlled. When it is chosen to initiate a conversation via the flow control 6, a timer function 7 is initiated at the same time. By means of the flow control, it is possible for the physician to go through predetermined conversation steps, which form the frame for, focus and create the contents of the interactive tools for the individual conversations. Equally, the colour in the flow line may be coordinated with the use of colours in the interactive tools.

However, it is possible to use a left menu with the patient's profile and tool data without starting the time and flow registration, see FIG. 2. With this, the physician can update the patient's health profile at all times independently from conversation flow and time registration, see FIG. 3. The health profile is based on scientific, quantifiable, relevant patient information, including basic data, demography, health (lung, cardiovascular diseases including sequela, blood pressure, diabetes including sequela, other chronic diseases, and other health problems), biological measurements (BMI, waist, blood pressure, cholesterol, blood sugar etc), physiological data (lung function and activity/activity level in the spare time and at work), as well as psychological data (experienced barriers in connection with illness), see FIG. 8. The said patient data are registered on a current basis but are processed simultaneously and summarized quantitatively directly in a health profile which provides an overview to both the physician and the patient of the development. This is evident from a processing of the data, as a difference is calculated between the recently registered data and the previously registered data. The development is shown by graph and arrows. All historic data can be monitored by clicking an icon for “history”. On the basis of the illustrations, the patient and the physician are guided so as to focus on these critical areas as starting point for the future conversations. Further, the values outside the normal spectrum are marked so that the patient and physician can quickly gain an overview of the most critical areas, which contributes to an agenda for the conversations.

The central pedagogic tools of the program are based on a system, which processes, organizes and relates registered data in specific data structures in relation to the use and the interaction between the compass, the action plan, the network chart, resources and gains, which will be explained in detail below.

After a conversation has been initiated, the compass is activated, see item 9, FIG. 1, whereby focus areas are selected and are graduated with a graduation barometer on a scale from 1-10 in relation to well-being today and in relation to well-being in future. This can be performed in a flexible way within the specific focus and life areas in either the entire compass or parts of the compass. The life areas are the four main areas in the compass, in this case spare time, work, family and health. The focus areas are selected lifestyle measures related to a life area, which the patient wants to go in depth with in connection with behavioural changes. It is possible to select either a predefined focus area or to draw up a new according to desire and to transfer this selection to the compass.

By means of a program in the language AJAX, the graduation and focus area selection is shown directly in the compass, see FIG. 4. Also, the graduation, see FIG. 5, renders it possible to measure the difference between present well-being and desired future well-being and to assess one's life in its entirety on the basis of the specific life areas. The graduation instantly gives the patient and the physician a joint picture of where the “well-being difference” is the largest and the smallest. FIG. 6 shows a compass with well-being difference in hierarchic overview.

In addition, concrete targets for the areas are drawn up, and the targets are registered in the database, are attached to and follow the individual life and focus areas for as long as these are being worked with and are active in the system for the patient.

FIG. 7 shows a compass with targets. Thus, the compass and target data provide subsequent focus for the behavioural changes in the action plan. By carried out intervention, the well-being areas of the compass are reviewed with a third graduation showing the experienced development of the patient in relation to the first well-being gap within the specific life and focus areas as well as future target areas.

FIG. 8 shows a compass with a final graduation.

This means, that in the action plan the patient can lay down new tasks related to the life and focus areas as well as the attached targets, see item 10. By wording and entering of the tasks into the input field of the action plan the user must subsequently activate a dialog box in order to select 1-3 resources from a predefined resource list and/or express a resource of his own desire and set a deadline for the completion of the task. The resource and deadline selection are attached to and follow the individual task everywhere in the database structure.

FIG. 9 shows an action plan for a new task.

The database structure of the action plan is based on four main lists, “future tasks”, “present tasks”, “performed tasks” and “deleted tasks”, which interact and process task data depending on the status of the tasks in the database.

Future tasks are registered on the list of “future tasks”, and when the deadline has exceeded and the patient needs to decide whether the task has been completed, the task appears automatically on a new list of “present tasks”, where it can be marked with the physician as being completed and/or permanent. When the task is marked as having been completed, its data is removed from the list of present tasks and transferred to a new list display under “completed tasks”, which is also considered as a kind of result list of the completed actions of the patient. This action also results in the related resource data being transferred to a new database for the resource chart, see item 11. When the present task is classified as “permanent” by marking with a check mark, the permanent task will continue having the status in the database as a present task, which must be decided on during each conversation, until the check mark is removed again. Last but not least, it is possible to transfer a task to the list display “deleted tasks”, from where the task may also be reactivated again upon desire.

FIG. 10 shows an example of selection of resources in connection with an action plan.

By means of flash programming, the resource chart shows the patient's resource status dynamically, see item 11, FIG. 1. The database of the resource chart is updated continuously on the basis of the completed tasks in the action plan. By calculation of the number of completed tasks combined with the temporal actuality of the tasks, the “hierarchic” position of the resource and its visual size in the resource chart are defined. Thus, the resource chart is divided into three levels, see FIG. 11, where the mostly and recently used resources gain the most central position in the resource chart. This way, the resource charts are uploaded to the primary, secondary and tertiary levels of the chart.

Further, it is possible to identify the history of the individual resources, as a database retrieval in the action plan may be performed by means of a mouse over of the individual resource words and at the same time show all connected task data, which were the cause of the individual resource.

FIG. 12 shows an example of a resource chart.

The completed task data of the action plan are also transferred to the database of “gains”, see item 12, FIG. 1. Together with the physician, the patient can allocate gains in the sub-menu “allocate gains” by clicking an icon, which activates a predefined list of gains enabling both the selection of an existing gain and the expression of a new desired gain, see FIG. 14.

The selection “allocate gains” is based on AJAX programming and is transferred directly to a “gain chart”, see FIG. 15, consisting of the four life areas, health, work, spare time and family, to which the tasks in the action plan were connected in the underlying database structure. This way, the system knows to which life area on the gain chart the individual gains are to be uploaded. On the basis of a calculation of the number of the completed tasks combined with the temporal actuality of the tasks, the visual size of the gains is defined in the gain chart.

As in the resource chart, it is also possible to identify the history for the individual gains, as a database retrieval in the action plan may be performed by means of a mouse over of the individual gain words and at the same time show all task data causing the gain.

In the network chart, see item 13, which is based on AJAX programming, it is possible to allocate resources and comments to persons' names. The object of the network chart is to visualize for the patient that he has resource persons who can support him in connection with the actions and the lifestyle changes. In the system, the network persons can be allocated a status of “most important”, “second most important” or “remote persons”. The network chart is also divided into the four life areas.

Further, it is possible to express individual tasks related to the persons registered in the life areas. The said task data related to the network chart, see FIG. 17, update the database of the action plan automatically.

When persons have been entered into the network chart, a small network icon appears in the tasks area of the action plan. By means of the AJAX programming and by mouse over, the network chart is opened and by clicking the names in the network chart, the persons' names are “attached” to the database of the task. This way, data can be retrieved from the database of the network chart and transferred to the action plan related to the individual tasks. In that way, it is easier for the patient to remember the resource persons in the network, who can be supportive in completing the task and achieving the target, see FIG. 18.

FIG. 19 shows an action plan with network chart.

### EXAMPLES

Example Regarding Smoking.

Question Guide for Health-Smoking

On the basis of your smoking habits please answer the following:

1. Status Item

On a scale from 1-10, how satisfied are you with your smoking habits in relation to your well-being and health?

Acknowledge the Problem:
How do you feel about smoking?
How much do you smoke each day?
What discomforts do you experience when smoking?

Then you have to assess your desire to change in relation to your smoking habits.

2. Change Item

On the basis of your status item, please rate on a scale from 1-10 your desire to change in relation to your smoking habits.

Can you accept the present situation or would you make a plan to improve the situation?

Sub-questions to the change item:
What do you hope for?
How important is it in your life?
How much priority will you give to it?
How much change will you create?

3. Target for the Focus Area

What is your main target regarding smoking?

Help the patient to express an understandable, manageable and meaningful target.

4. Behavioural Specific Tasks

What tasks/steps do you need to undertake towards the target?

Measures (the Patient Himself):
Have you considered stopping smoking?
What gains are there for you by stopping smoking?
Do you consider a gradual reduction or a “cold turkey”?
What can you do instead of smoking? (substitute)
If you do not want stop, how much are you able to reduce your smoking?
Who can support you in achieving your target?
What could motivate you into stopping smoking?
How would you plan your smoking cessation/reduction of your smoking?
What do you think is the biggest challenge for you in relation to smoking? How are you going to deal with it?

Suggestions (From the Physician):
Could you start by reducing the daily number of smoked cigarettes with a certain number?
Could your family support you without being judgemental?
Could you find other things to do, which could distract you in the situation where you want to smoke? For instance plan an activity with your family, go for a walk when you come home, engage yourself in your spare time activities (do the car, sew, knit, paint etc.). Make suggestions for substitutes yourself.
Could you join a smoking cessation course?

5. Deadline
When do you wish to commence the task and when is it completed?(it is the deadline for the completion which is to be entered)

6. Resource
What resource do you need to use when completing the task?
What would be helpful to you in that situation?
What does it take for you to do it?

Example Regarding Weight

Question Guide for Health-Weight

On the basis of your present weight please answer the following:

1. Status Item

On a scale from 1-10, how satisfied are you with your weight in relation to your well-being and health?

Acknowledge the Problem:
How big a problem is your weight for you?
What do you think is the cause of your weight (bad food, too little exercise etc.)?
What would like help for to do differently?
What do you eat that you do not need to eat?

Then you have to assess your desire to change in relation to your weight.

2. Change Item

On the basis of your status item, please rate on a scale form 1-10 your desire to change in relation to your weight.

Can you accept the present situation or would you make a plan to improve the situation?

Sub-Questions to the Change Item:
What do you hope for?
How important is it in your life?
How much priority will you give to it?
How much change will you create?

3. Target for the Focus Area

What is your main target regarding your weight?

Help the patient to express an understandable, manageable and meaningful target.

4. Behavioural Specific Tasks

What tasks/steps do you need to undertake towards the target?

Measures (the Patient Himself):
How do you think you can achieve your target in relation to weight?
What can motivate you to behave so that you lose weight? What can you do to your food?
What goodies do you eat daily/weekly? (sweets, chocolate, biscuits, potato chips, cake, ice cream)
What can you eat instead of what you should not eat?
What could you do to be more physically active?
What exercise could you do?
What gains would you have in connection with loss of weight?
What do you think is the biggest challenge for you in relation to your weight?
   How are you going to deal with it?

Suggestions (from the Physician:
Could you write down what you eat daily for a period of 1-2 weeks?
Could you drink water instead of lemonade or soft drinks?
Could you bike to work for instance instead using the car, taking the train or bus?
Could you go for a daily brisk walk of 30 minutes?
Could you join an exercise class, with an exercise you like?
Could you join a team supporting each other in achieving your target?

5. Deadline
When do you wish to commence the task and when is it completed?(it is the date of the completion which is to be entered)

6. Resource
What resource do you need to use when completing the task?
What would be helpful to you in that situation?
What does it take for you to do it?

Other examples relating to health could relate to alcohol, medicine consumption, food, stress and other psychological problems in general.

The method for improving the patient's condition is in principle the same for all cases. The problem is analyzed and it is reviewed what needs to be done in order to obtain a desired change, whereupon it is examined what realistic tasks may pave the way for the patient towards the target, as well as the inner resources that may be used.

In the following there are examples of resources which may be used.
1. Active
2. Conscientious
3. Enthusiasm
4. Decisive
5. Efficient
6. Committed
7. Focussed
8. Flexible
9. Assertive
10. Drive
11. Helpful
12. Humorous
13. Inventive
14. Persistent
15. Impulsive
16. Full of initiative
17. Intuitive
18. Communicative
19. Creative
20. A good listener
21. Brave
22. Motivated
23. Goal-oriented
24. Curious
25. Considerate
26. Fertile
27. Optimistic
28. Breath of view
29. Planning
30. Dutiful
31. Practical
32. Result-oriented
33. Cooperative
34. Confident
35. Structured
36. Stubborn
37. Patient
38. Persevering
39. Determined
40. Open

1. Computerized healthcare management method for a patient using a prosperity compass for illustrating and structuring an action plan base for an analyzation and evaluation of the results of actions performed.

2. Method according to claim 1, wherein the analyzation comprises an analyzation of the results of the actions performed so as to provide causality.

3. Method according to claim 1, wherein the prosperity compass comprises a sector concerning health, a sector concerning family, a sector concerning work and a sector concerning spare time.

4. Method according to claim 1, wherein the analyzation comprises an evaluation of the necessary resources for the actions to be performed.

5. Method according to claim 1, wherein the analyzation comprises an evaluation of priority.

6. Method according to claim 1, wherein the analyzation comprises a measurement of the progress.

7. Method according to claim 1, wherein the evaluation comprises an evaluation of the patient's network for supporting the progress.

8. Method according to claim 1, wherein the evaluation comprises an evaluation of the patient's experienced gains after having completed one or several actions.

9. Method according to claim 1, wherein the analyzation comprises an evaluation of causality between action and progress.

10. Method according to claim 1, wherein the evaluation comprises an evaluation of the patient's resources.

11. Method according to claim 10, wherein the evaluation of the patient's resources comprises an evaluation of unconscious resources.
